(19) United States
(12) Patent Application Publication
(10) Pub. No.: US 2011/0175001 A1
(43) Pub. Date: Jul. 21, 2011

(54) GRAVITY DRIVEN VALVE SWITCH

(76) Inventor: MING-TUNG LIU, Taipei (TW)

(21) Appl. No.: 12/687,880

(22) Filed: Jan. 15, 2010

(51) Int. Cl. F16K 31/00

(52) U.S. Cl. 251/76

(57) ABSTRACT

A gravity driven valve switch includes an acted component, which defines an internal receiving space having a bottom forming a through hole; an acting component, which is received in the acted component; and a driving component, which is arranged below the acted component in a movable manner and forms at least one through hole. The acting component forms a coupling portion and the driving component forms a connection section that is received through the through hole of the acted component whereby the coupling portion and the connection section are engageable with each other to allow for easy coupling and separation of the acting component and the driving component and whereby the driving component provides a weight that, together with a gravitational force acting on the acting component, drives the acting component downward to precisely and tightly seal the through hole of the acted component.

### TECHNICAL FIELD OF THE INVENTION

The present invention generally relates to a valve switch, and more particularly to a gravity driven valve switch, which allows for easy mounting and separation, allows for precise and tight sealing of an acted component, allows for a target object contained inside an acted component to smoothly drain/dispense, and provides a safety function against undesired contact.

### DESCRIPTION OF THE PRIOR ART

A valve functions to freely close and/or open a passage and is commonly used in various products to conveniently control the drain or dispensing of a target object, such as a fluid or a solid, out of a receiving space.

A known valve comprises a metal object set in a passage. The metal object can be pushed away by a push bar so that the fluid or solid passing through the passage is controlled by the metal object sealing the passage or not. In this way, the operation of the valve is realized. However, such a valve made up of the metal object and the push bar has some disadvantages:

(1) The metal object is not coupled to the push bar and is not additionally constrained by any constraint structure, so that the metal object may roll in an irregular manner, making it not possible to precisely block the passage thereby leading to leaking of the target object through the passage.

(2) The metal object seals the passage by its own weight and is not driven by an additional force provided under the metal object. Since the weight of the metal object may not be sufficiently to completely block the passage, it is still possible to occur leaking through the passage.

(3) When the metal object is pushed away by the push bar to open the passage, due to the fact that the metal object being not coupled to the push bar, the metal object may still be allowed to rotate to the location of the passage, so that the passage is still in partial blockade by the metal object, which prevents the target object from being smoothly dispensed through the passage.

(4) The push bar is often mounted to an object having a larger outside diameter and the object is not covered by any protective sheath, so that the object is often subjected to undesired contact by a user, leading to the movement of the push bar to push away the metal object, which prevents the metal object from properly closing the passage and eventually causes leakage.

In view of these problems, a valve must be constructed to allow the passage to be precisely and tightly closed, but easy to open and the valve must be easily assembled and has effective protection against undesired contact.

### SUMMARY OF THE INVENTION

The objective of the present invention is to provide a gravity driven valve switch that features comprising an acted component that can be precisely and tightly closed, smooth dispensing of a target object received in the acted component, and protection against undesired contact. Structurally, the gravity driven valve switch of the present invention comprises an acted component, which defines an internal receiving space having a bottom forming a through hole; an acting component, which is received in the acted component; and a driving component, which is arranged below the acted component in a movable manner and forms at least one through hole. The acting component forms a coupling portion and the driving component forms a connection section that is received through the through hole of the acted component whereby the coupling portion and the connection section are engageable with each other to allow for easy coupling and separation of the acting component and the driving component and whereby the driving component provides a weight that, together with a gravitational force acting on the acting component, drives the acting component downward to precisely and tightly seal the through hole of the acted component or the driving component, when acted upon by a pushing force, drives the acting component upward to completely open the through hole of the acted component; and the acted component has a lower circumference forming a flange that has a diameter greater than the driving component in order to protect the driving component from being contacted by an external force to ensure protection and safety.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a gravity driven valve switch constructed in accordance with an embodiment of the present invention.

FIG. 2 is an exploded view of the gravity driven valve switch of the present invention.

FIG. 2A is a cross-sectional view, in an enlarged form, of a sleeve of the gravity driven valve switch of the present invention.

FIG. 3 is a perspective view of a driving component of the gravity driven valve switch of the present invention in a reversed condition.

FIG. 4 is a cross-sectional view illustrating the gravity driven valve switch of the present invention is closed to block a target object.

FIG. 5 is a cross-sectional view illustrating the gravity driven valve switch of the present invention is open to release the target object.

FIG. 5A is an enlarged view of a portion of the gravity driven valve switch shown in FIG. 5.

FIG. 6 is a cross-sectional view of a gravity driven valve switch according to an embodiment of the present invention, which further includes a barrier.

FIG. 7 is a cross-sectional view of a gravity driven valve switch according to the present invention, showing a second embodiment of connection between a coupling portion of an acting component and a connection section of a driving component of the gravity driven valve switch.

FIG. 8 is a cross-sectional view of a gravity driven valve switch according to the present invention, showing a third embodiment of connection between a coupling portion of a acting component and a connection section of a driving component of the gravity driven valve switch.

FIG. 9 is a cross-sectional view of a gravity driven valve switch according to the present invention, showing a fourth embodiment of connection between a coupling portion of a acting component and a connection section of a driving component of the gravity driven valve switch.

FIG. 10 is a cross-sectional view of a gravity driven valve switch according to the present invention, showing a fifth embodiment of connection between a coupling portion of a acting component and a connection section of a driving component of the gravity driven valve switch.

FIG. 11 is a cross-sectional view of a gravity driven valve switch according to the present invention, showing a sixth embodiment of connection between a coupling portion of a acting component and a connection section of a driving component of the gravity driven valve switch.

FIG. 12 is a cross-sectional view of a gravity driven valve switch according to the present invention, showing a seventh embodiment of connection between a coupling portion of a acting component and a connection section of a driving component of the gravity driven valve switch.

FIG. 13 is a cross-sectional view of a gravity driven valve switch according to the present invention, showing an eight embodiment of connection between a coupling portion of an acting component and a connection section of a driving component of the gravity driven valve switch.

FIG. 14 is a cross-sectional view of a gravity driven valve switch according to the present invention, showing a ninth embodiment of connection between a coupling portion of a acting component and a connection section of a driving component of the gravity driven valve switch.

FIG. 14A is a perspective view, in an enlarged form, of a portion of the gravity driven valve switch shown in FIG. 14.

FIG. 15 is a cross-sectional view of a gravity driven valve switch according to the present invention, showing a tenth embodiment of connection between a coupling portion of a acting component and a connection section of a driving component of the gravity driven valve switch.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

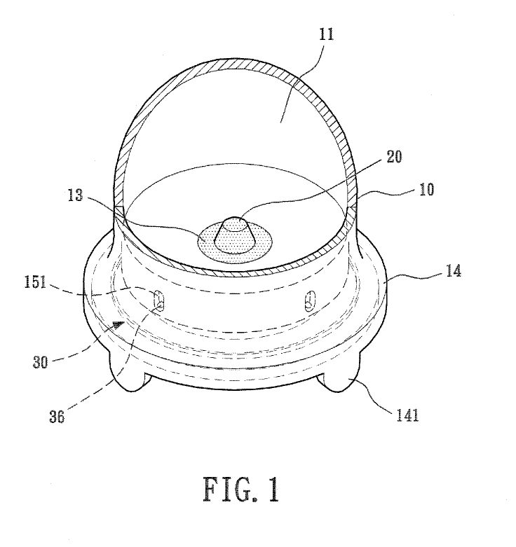

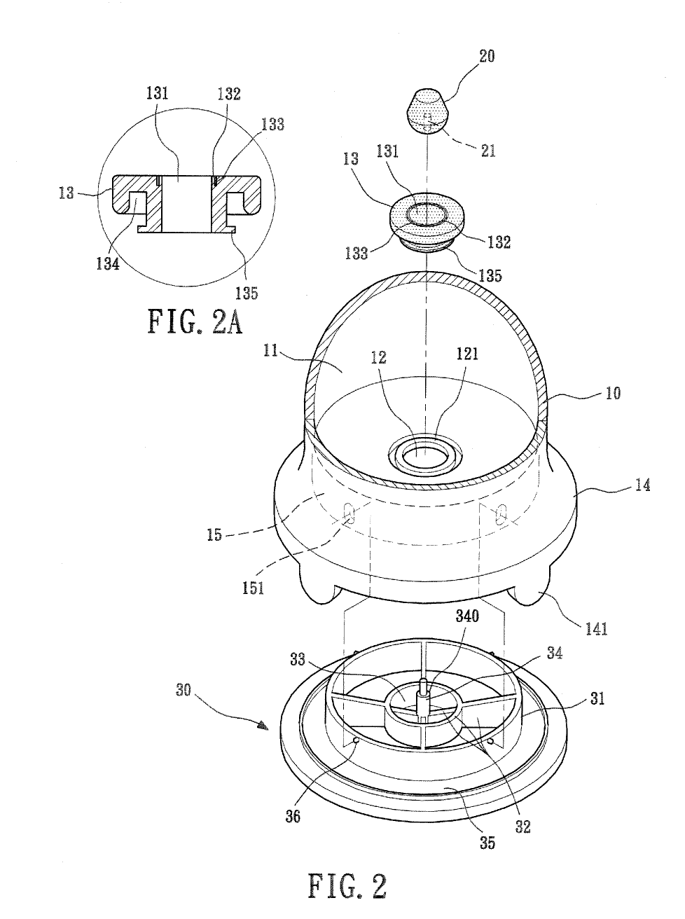

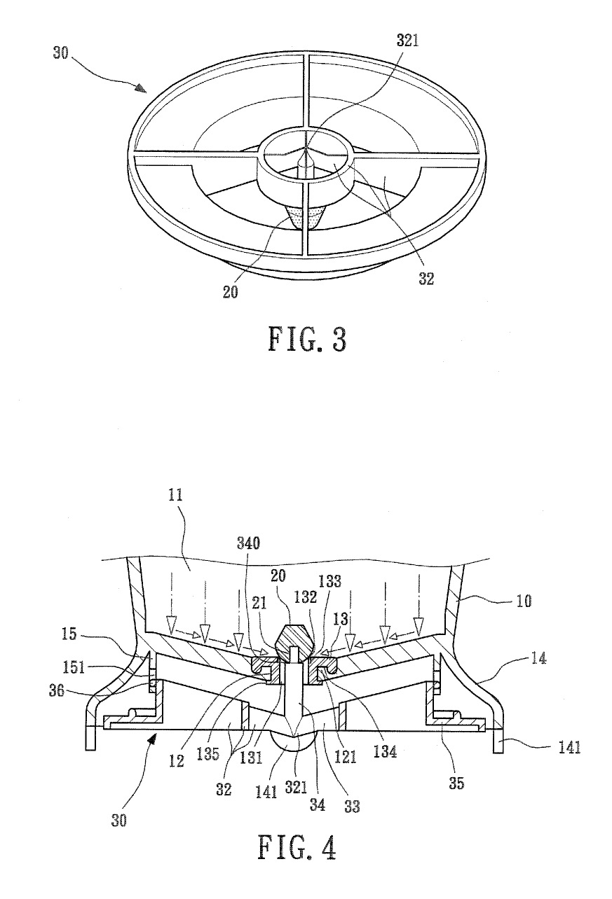

Referring to FIGS. 1, 2, 2A, 3, and 4, a gravity driven valve switch according to an embodiment of the present invention comprises an acted component 10, an acting component 20 arranged inside the acted component 10, and a driving component 30 arranged under the acted component 10. These components will be further described in the following.

The acted component 10 defines an internal receiving space 11 that receives a target object, such as a fluid, a solid, or powders. The acted component 10 has a bottom of the internal space that defines a through hole 12 and a circumferential projection 121 is formed around the through hole 12. The internal bottom of the acted component 10 is inclined at a predetermined slope to effectively conduct the target object to the through hole 12. The through hole 12 receives therein a sleeve 13 that defines a bore 131. The bore 131 has an upper circumference along which a contact wall 132 is formed and a groove 133 is formed adjacent the contact wall 132 to provide the contact wall 132 with sufficient resiliency for deformation in order to form tight engagement with the acting component 20. The sleeve 13 forms a retention slot 134 and a retention ring 135 at suitable locations. The retention slot 134 is fit over the projection 121 and the sleeve 13 is securely retained inside the through hole 12 by the retention ring 135 engaging a counterpart portion of the through hole 12. The acted component 10 has a lower circumference forming a flange 14 having a diameter greater than the driving component 30 whereby the driving component 30 is covered by the flange 14. The flange 14 forms a plurality of support legs 141 so that the acted component 10, when positioned on a fixture surface, is prevented from easily tipping, stability and safety are enhanced, and manufacturing and assembling are made easy. The acted component 10 forms outside the bottom thereof a support 15 in which a plurality of slide slots 151 is defined.

The acting component 20 can be made of a resilient material, such as rubber and forms a coupling portion 21 (which in the embodiment illustrated, is made in the form of a hole). The acting component 20 is provided for close the bore 131 of the sleeve 13 to prevent the acted component 10 from leaking under a normal condition. It is apparent that the sleeve 13 can be omitted and the acting component 20 functions to directly close the through hole 12.

The driving component 30 comprises a base 31 that comprises a plurality of ribs 32, a plurality of through holes 33, and a connection section 34 and an extension 35 set below the base 31. The base 31 has a circumferential surface forming a plurality of pegs 36 corresponding to the slide slots 151. The pegs 36 are received in the slide slots 151 so that the pegs 36 do not detach from the slide slots 151 and are movable up and down inside the slide slots 151 to thereby make the driving component 30 movable up and down under the acted component 10. The through holes 33 allow the target object to pass therethrough for moving downward. The connection section 34 is in the form of a cylinder and extends through the bore 131 to fit into and thus couple to the coupling portion 21 of the acting component 20. The coupling made between the connection section 34 and the coupling portion 21 allows for easy coupling and separation of the driving component 30 and the acting component 20. If desired, adhesives can be applied at the location where the coupling is made to improve the connection therebetween. The connection section 34 forms a step 340 that provides a stop for fitting the acting component 20. The ribs 32 intersect at a central portion that a bottom portion forming a cone 321. When the driving component 30 is moved upward, the acting component 20 is driven to separate from the bore 131 to thereby release the closed condition of the bore 131.

Referring to FIG. 4, to use, the acted component 10 is positioned on a fixture surface and the driving component 30 is acted upon by gravity to move downward. Due to the physical principle f gravitation, the acting component 20 is driven downward by its own weight and the gravitation force caused by the driving component 30 to precisely and tightly seal the bore 131 in order to prevent the target object inside the acted component 10 from falling down.

The contact wall 132 of the sleeve 13 is acted upon by the gravity of the acting component 20 and is thus expanded and such an expansion induces inward shrinkage that causes the contact wall 132 to tightly abut against the surface of the acting component 20 thereby enhancing the result of leakage prevention.

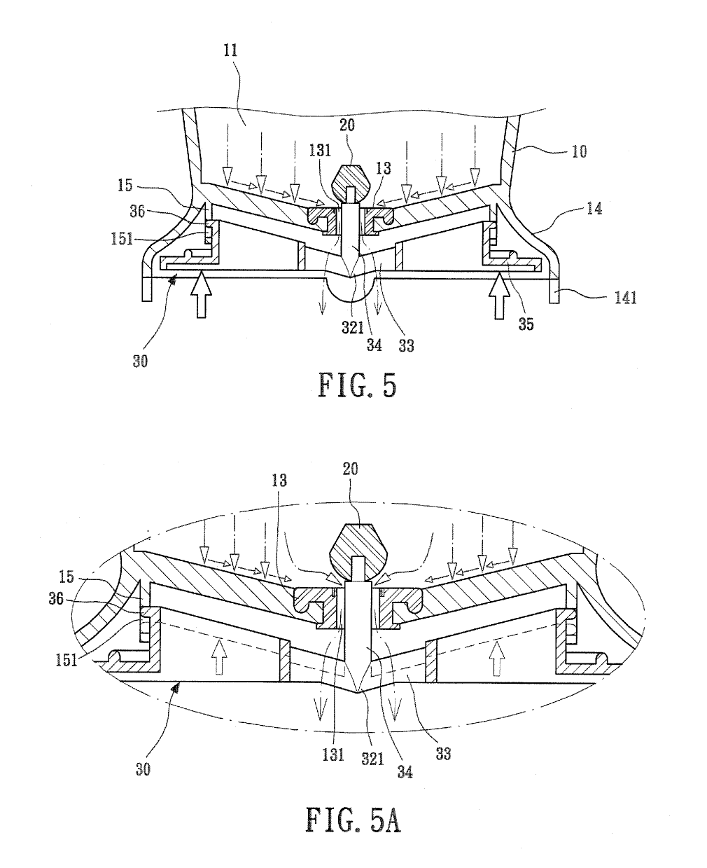

Referring to FIGS. 5 and 5A, when the bottom of the driving component 30 is acted upon by an upward pushing force (such as being pushed by a hand or the acted component 10 being positioned on a container), the driving component 30 and the connection section 34 are moved upward simultaneously to displace the acting component 20 upward for separation from the bore 131, thereby owning the sleeve 13 to allow the target object inside the acted component 10 to pass through the bore 131 and the through holes 33 for draining/dispensing. Since the acting component 20 is totally separated from the bore 131, the bore 131 is fully open and the drain of the target object is smooth.

The cone 321 helps conducting and concentrating the target object to the central portion for draining so that no residual of the target object will remain on the driving component 30.

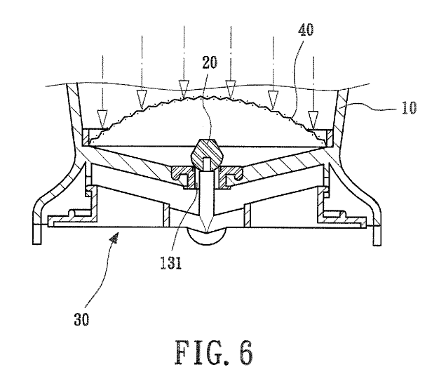

Referring to FIG. 6, the acted component 10 can further comprise a screen-like barrier 40 to block large objects or undesired object from passing through the bore 131 and to help preventing the bore 131 from being blocked up.

Referring to FIG. 7, the coupling portion 21 of the acting component 20 can form a projecting portion 211 therein to cooperate with a recessed portion 341 formed in the connection section 34 to form fitting connection between the acting component 20 and the connection section 34 for enhancing the coupling strength therebetween.

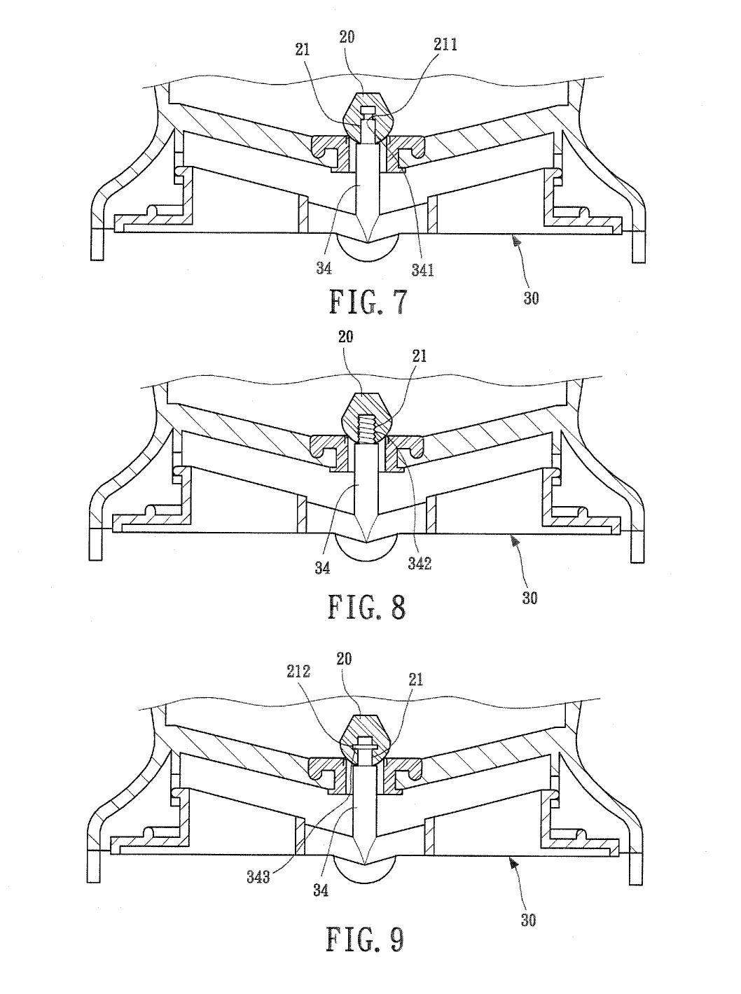

Referring to FIG. 8, the coupling portion 21 of the acting component 20 may be alternatively made in the form of a threaded hole to mate a thread 342 formed on the connection section 34 so that a threaded connection between the acting component 20 and the connection section 34 for enhancing the coupling strength therebetween.

Referring to FIG. 9, the coupling portion 21 of the acting component 20 may alternatively form a recessed portion 212 therein to cooperate with a projecting portion 343 of the connection section 34 to form fitting connection between the acting component 20 and the connection section 34 for enhancing the coupling strength therebetween.

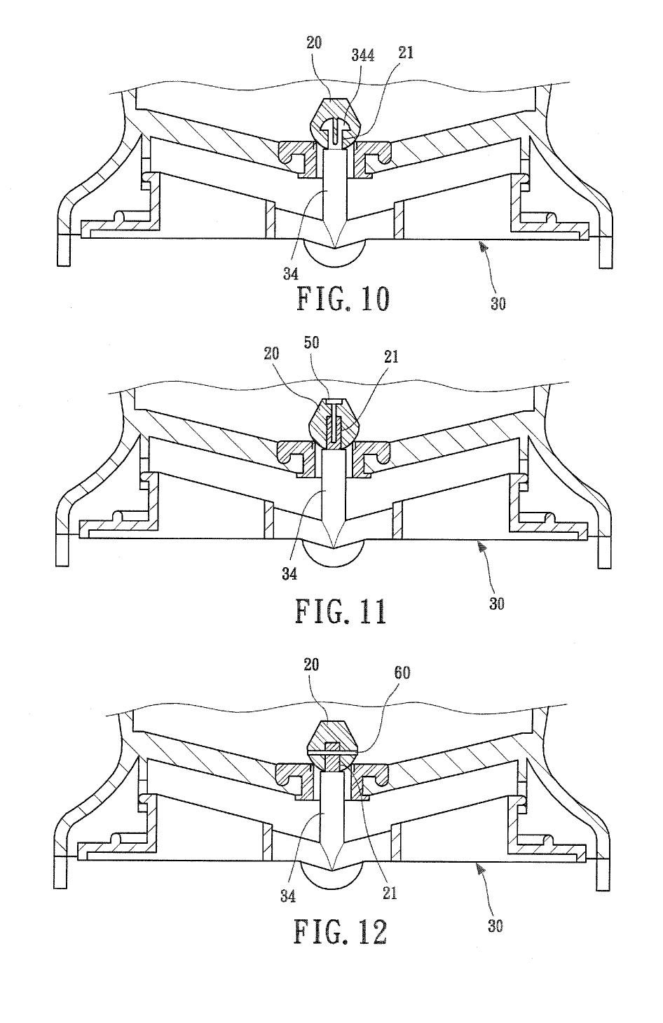

Referring to FIG. 10, the connection section 34 alternatively forms a barbed bar 344 and the coupling portion 21 of the acting component 20 is made a hole of a shape corresponding to the barbed bar 344 so that a fitting connection can be formed between the acting component 20 and the connection section 34 for enhancing the coupling strength therebetween.

Referring to FIG. 11, a fastener 50 can be further included to penetrate in a vertical direction through the coupling portion 21 of the acting component 20 and the connection section 34, after they are assembled together, so as to enhance the coupling strength therebetween.

Referring to FIG. 12, a fastener 60 can be further included to penetrate in a horizontal direction through the coupling portion 21 of the acting component 20 and the connection section 34, after they are assembled together, so as to enhance the coupling strength therebetween.

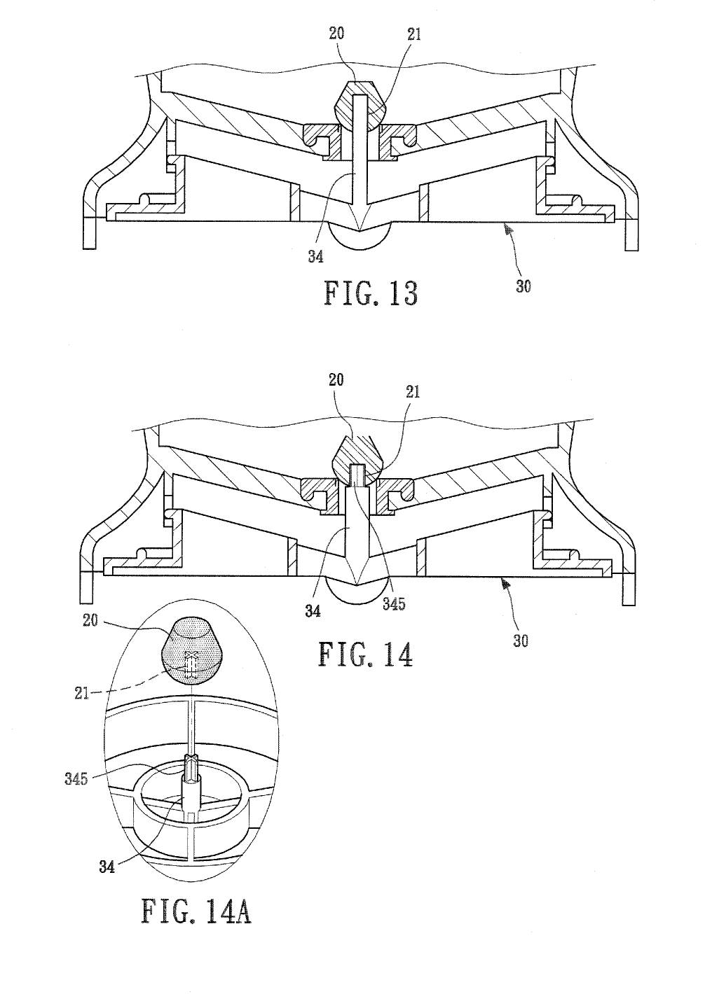

Referring to FIG. 13, the coupling portion 21 of the acting component 20 is made in the form of a hole, while the connection section 34 is in the form of a straight cylinder without a step formed thereon, whereby the connection section 34 can be directly fit into the acting component 20 to form coupling therebetween.

Referring to FIGS. 14 and 14A, the connection section 34 is made in the form of a multi-bladed bar 345 having multiple side blades, while the coupling portion 21 of the acting component 20 is made in the form of a hole having a shape corresponding to the multi-bladed bar 345, whereby the connection section 34 can be fit into the acting component 20 to form coupling therebetween.

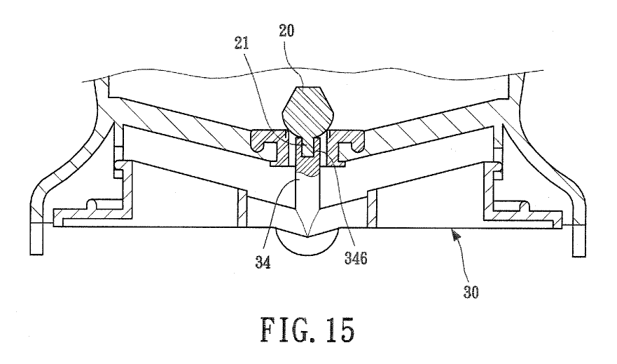

Referring to FIG. 15, alternatively, the coupling portion 21 of the acting component 20 is made in the form of a projecting bar, while the connection section 34 forms a hole 346 corresponding to the coupling portion 21 in order to form a fitting connection between the acting component 20 and the connection section 34.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A gravity driven valve switch, comprising:
an acted component, which defines an internal receiving space having a bottom forming a through hole;
an acting component, which is received in the acted component; and
a driving component, which is arranged below the acted component in a movable manner and forms at least one through hole;
characterized in that:
the acting component forms a coupling portion and the driving component forms a connection section that is received through the through hole of the acted component whereby the coupling portion and the connection section are engageable with each other to allow for easy coupling and separation of the acting component and the driving component and whereby the driving component provides a weight that, together with a gravitational force acting on the acting component, drives the acting component downward to precisely and tightly seal the through hole of the acted component or the driving component, when acted upon by a pushing force, drives the acting component upward to completely open the through hole of the acted component; and
the acted component has a lower circumference forming a flange that has a diameter greater than the driving component in order to protect the driving component from being contacted by an external force to ensure protection and safety.

2. The gravity driven valve switch according to claim 1, wherein the through hole of the acted component receives therein a sleeve that is made of a resilient material and defines a bore and wherein the bore has an upper circumference along which a contact wall is formed to provide a tight engagement with the acting component.

3. The gravity driven valve switch according to claim 2, wherein a circumferential projection is formed around the through hole of the acted component and wherein the sleeve forms a retention slot and a retention ring, the retention slot being fit over the projection and the sleeve being securely retained inside the through hole of the acted component by the retention ring engaging a counterpart portion of the acted component.

4. The gravity driven valve switch according to claim 2, wherein a groove is formed in and adjacent to the contact wall of the sleeve.

5. The gravity driven valve switch according to claim 1, wherein the through hole of the driving component is provided with a plurality of ribs that intersect at a central portion having a bottom forming a cone.

6. The gravity driven valve switch according to claim 1, wherein the acted component forms on an underside thereof a support in which a plurality of slide slots 151 is defined and wherein the driving component forms a plurality of pegs corresponding to the slide slots, whereby the pegs are received in the slide slots so that the pegs are movable up and down inside the slide slots to thereby make the driving component movable up and down under the acted component.

7. The gravity driven valve switch according to claim 1, wherein the connection section forms a step that provides a stop for fitting the acting component.

8. The gravity driven valve switch according to claim 1, wherein one of the coupling portion of the acting component and the connection section of the driving component is in the form of a hole and the other is in the form of a bar to allow for fitting connection between the coupling portion and the connection section.

9. The gravity driven valve switch according to claim 8, wherein one of the hole and the bar forms a projecting portion, while the other forms a recessed portion for forming fitting connection therebetween.

10. The gravity driven valve switch according to claim 1, wherein the coupling portion of the acting component and the connection section of the driving component are threadingly coupled to each other through threaded structures.

11. The gravity driven valve switch according to claim 1, wherein one of the coupling portion of the acting component and the connection section of the driving component is in the form of a barbed bar, while the other is made a hole of a shape corresponding to the barbed bar to allow for a fitting connection between the acting component and the driving component.

12. The gravity driven valve switch according to claim 1 further comprising a fastener penetrating through the coupling portion of the acting component and the connection section of the driving component.

13. The gravity driven valve switch according to claim 1, wherein one of the coupling portion of the acting component and the connection section of the driving component is in the form of a multi-bladed bar, while the other is made a hole of a shape corresponding to the multi-bladed bar to allow for a fitting connection between the acting component and the driving component.
